(19) United States
(12) Patent Application Publication
(10) Pub. No.: US 2017/0136735 A1
(43) Pub. Date: May 18, 2017

(54) Engineered Plank and its Manufacturing Method

(71) Applicant: Wellmade Floor Covering Int'l Inc., Wilsonville, OR (US)

(72) Inventors: Ming Chen, Wilsonville, OR (US); Zhu Chen, Nanjing (CN)

(21) Appl. No.: 15/145,667

(22) Filed: May 3, 2016

Related U.S. Application Data
(63) Continuation of application No. 14/997,965, filed on Jan. 18, 2016.

(30) Foreign Application Priority Data
Nov. 17, 2015 (CN) 201510794065.2
Nov. 17, 2015 (CN) 201510794113.8
Nov. 17, 2015 (CN) 201520919804.1
Nov. 17, 2015 (CN) 201520919986.2

(51) Int. Cl. B32B 7/04; B29C 47/00

(52) U.S. Cl. CPC B32B 7/04; B29C 47/0064; B29L 2031/10

(57) ABSTRACT

A plank is described and a method for manufacturing the plank. The plank can be produced by mixing polyvinyl chloride powder, coarse whiting and light calcium compound powder, stabilizer, polyethylene wax, internal lubricant, plasticizer, and impact modifier together, and stirring this mixture. The mixture is then extruded through an extruder compound to form a plastic composite base material. A surface layer is then tiled onto the plastic composite base material using thermal compression, without the use of intermediate adhesive materials.

### CROSS-REFERENCES TO PRIORITY AND RELATED APPLICATIONS

The present application is a continuation of U.S. patent application Ser. No. 14/997,965, filed Jan. 18, 2016.

This application claims priority from one or more of the following:
Chinese Patent Appl. No. 201510794065.2, filed Nov. 17, 2015 and entitled “Flooring with Fastener”;
Chinese Patent Appl. No. 201510794113.8, filed Nov. 17, 2015 and entitled “Flooring with Fastener”;
Chinese Patent Appl. No. 201520919804.1, filed Nov. 17, 2015 and entitled “Flooring with Fastener”; and
Chinese Patent Appl. No. 201520919986.2, filed Nov. 17, 2015 and entitled “Flooring with Fastener”.
The entire disclosures of the application recited above are hereby incorporated by reference, as if set forth in full in this document, for all purposes.

### FIELD OF THE INVENTION

The invention relates to building materials, especially involving an engineered plank and its production method.

### BACKGROUND

Most flooring planks contain wood or wood byproducts. For example, wood-plastic composite (WPC) engineered planks use a sandwich-structure composite including different layers of different materials. For example, a WPC plank may have wood polymer composite skins and a low-density polymer core, which leads to an effective increase in the panel's rigidity. In some aspects, WPC planks may include a surface, printing color film, a wearing layer, and a WPC substrate.

One process for making WPC planks might be divided into three steps: (1) gluing a surface layer and drawing paper into a composite layer; (2) extruding and forming a thick WPC substrate; and (3) compressing and pasting together the glued surface layer, drawing paper and WPC substrate. The WPC substrate uses wood powder, which can result in a waste of resources, as it can affect the finish of the goods or create mustiness. Accordingly, glue is used to compress and paste the layers in the manufacturing process. Further, WPC engineered plank inevitably contains formaldehyde that causes environmental pollution. WPC processing technology may also need coating processes which may increase the required number of processing steps, and may make continuous production more difficult.

Therefore, improved engineered planks and improved methods for manufacturing engineered planks may be desired.

### SUMMARY

In embodiments of the present invention, an improved engineered plank is provided that overcomes some of the shortcomings of existing WPC plank technologies. A plank is described and a method for manufacturing the plank. The plank can be produced by mixing polyvinyl chloride powder, coarse whiting and light calcium compound powder, stabilizer, polyethylene wax, internal lubricant, plasticizer, and impact modifier together, and stirring this mixture. The mixture is then extruded through an extruder compound to form a plastic composite base material. A surface layer is then tiled onto the plastic composite base material using thermal compression, without the use of intermediate adhesive materials.

The following detailed description, together with the accompanying drawings, will provide a better understanding of the nature and advantages of the present invention.

### BRIEF DESCRIPTION OF THE DRAWINGS

FIG. 1 is a diagram of a structure of an engineered plank.

FIG. 2 is another diagram of a structure of an engineered plank.

FIG. 3 is another diagram of a structure of an engineered plank.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein. The present disclosure provides additional detail to be read with the appended figures.

As described above, WPC flooring plank technology has a number of limitations. Problems with existing WPC plank technologies include their manufacturing methods, which result in products containing formaldehyde. Existing WPC planks also use wood powder, which tends to waste resources and can lead to a complicated manufacturing process with difficulty in continuous production. Existing WPC planks also use glue pressure paste, which may lead to rickety products for technological or operational reasons. Accordingly, plank technology that addresses these limitations is desired.

These limitations may be overcome by using an engineered floor plank using High Density Plastic Composite Core (HDPCC) technology. This plank may allow for additional density and resistance to indentation when compared to existing WPC planks. Additionally, this technique may not require the use of any glue, which may lead to more high-quality products. One technique used to create improved engineered floor planks may be referred to as co-extrusion and a continuous-press process (CPP). This avoids using a hot glue melt, as in previous techniques, which can result in an adhesive breakdown and may delaminate the plank.

The engineered planks described herein include a surface layer and a plastic composite substrate layer which are thermally-compressed and pasted with each other, without requiring the use of glue. The surface layer of such a plank may be constructed from many different types of materials, and can include one or more of ceramic, tile, glass, rubber, plastic, paper, leather, metal materials, stone, cloth, carpet and cork. The plastic composite substrate layer (or plastic composite base material layer) may be extruded from a mixture of one or more of polyvinyl chloride (PVC) powder, coarse whiting and light calcium compound powder, stabilizer, polyethylene (PE) wax, internal lubricant, plasticizer, and impact modifier. For example, the plastic substrate of a plank may be made using PVC powder, course whiting and light calcium powder, and stabilizer. The plank may also be made without using light calcium powder. The plastic composite substrate layer may be extruded and compounded by a layer of plastic substrate. In some aspects, the plastic composite substrate layer may be extruded and compounded by two or more layers of plastic substrate.

Where the surface layer is amenable to being pressed through rollers, the surface layer can be pressed onto the hot plastic composite substrate layer using rollers. Where the surface layer is not amenable to being pressed through rollers, such as with stone, tile, etc., the surface layer can be pressed onto the hot plastic composite substrate layer just after the hot plastic composite substrate layer exits the rollers, or soon enough after so that the plastic composite substrate layer is still hot.

One method of producing an engineered plank as described herein includes the following steps:
Step 1: Mix PVC powder with coarse whiting and light calcium compound powder, stabilizer, PE wax, internal lubricant, plasticizer, and impact modifier by proportion of weight. Each of these components may be added in different quantities, or may be excluded as desired. This mixture may then be stirred. In some aspects, during the hot mixing process, the mixture temperature may be controlled to be approximately 110-120° C. For example, it may be desired to keep the mixture within 5, 10, 15, or 20° C. from 115° C. during this hot mixing process. Some subset of these components might be mixed in a cold mixing process prior to being mixed with the other components in the hot mixing process.
Step 2: The mixture may then be extruded. The extruded product may be a compound which then forms the plastic composite substrate layer. Extrusion might involve a three-roll calender.
Step 3: A surface layer may then be tiled onto the extruded plastic composite base material in a fixed position. For example, this may be done using a three-roll calender to bond and paste the surface layer and the plastic composite substrate layer together. In some aspects, each roll of the calender may be kept at a specific temperature. For example, the first roll of the calender may be kept at 130° C., or between 120 and 140° C., while the second roll is kept at 120° C., or between 110° C. and 130° C., and the third roll of the calender may be kept at 110° C., or between 100° C. and 120° C. It should be understood that a calender with less than or more than three rolls might also be used for this step, or other machines to bond and paste the two layers together may also be used. In some aspects, controlled temperatures may be used when bonding and pasting the surface layer. For example, the temperature may be maintained to be between 150° C. and 200° C.
Step 4: After this, the plank may be cooled, sized, and cut into the desired dimensions, based on the needs of the particular project or the plank design.

As described above, this engineered plank does not require the use of wood powder, which saves natural wood material. Thermal compression and pasting the surface layer and plastic composite substrate layer using the temperature from the extrusion process can avoid the production of formaldehyde during production, by not using glue to press and paste the layers together. Further, it may be much easier to continuously produce the engineered planks described herein than it is to produce planks that include a glue coating process. This may make automated production possible, which may improve production efficiency, as well as enhance the stability of the adhesion between the layers of the engineered plank.

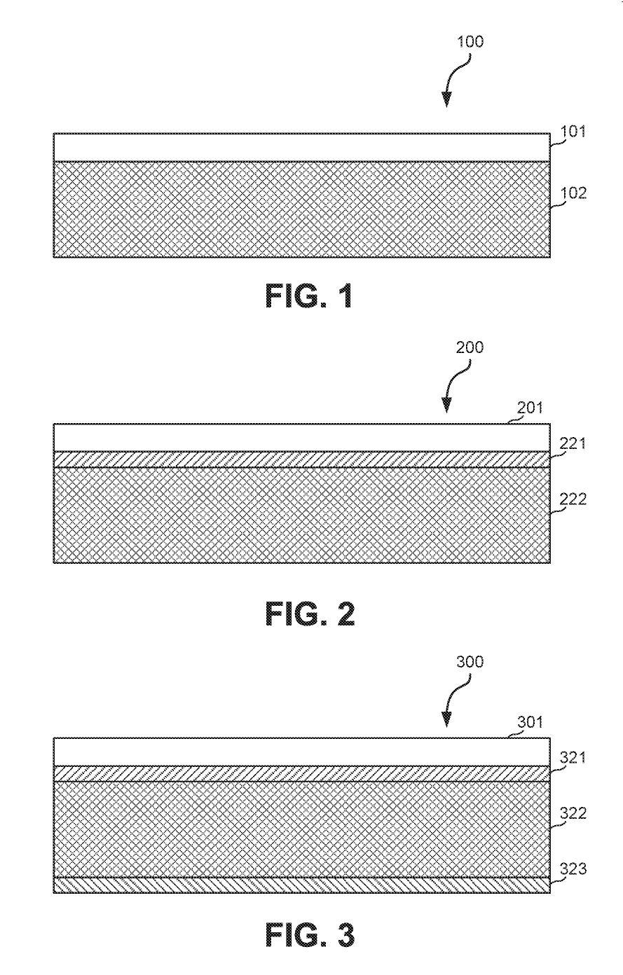

FIG. 1 illustrates an exemplary engineered flooring plank 100 according to some aspects of the present disclosure. As illustrated, engineered flooring plank 100 includes a surface layer 101 and a plastic composite substrate layer 102. Surface layer 101 and plastic composite substrate layer 102 are thermal compressed and pasted together. As described above, this technique avoids the use of glue and does not produce formaldehyde. Using a thermal compression process to securely attach surface layer 101 and plastic composite substrate layer 102 together may also lead to production advantages over other techniques, such as allowing continuous production by reducing the glue coating process. Accordingly, engineered flooring plank 100 may be produced using more automated production, improving production efficiency and enhancing the stability of composite plate adhesion between layers 101, 102.

Surface layer 101 may be made from materials such as ceramic, tile, glass, rubber plastic, paper, leather, metal materials, stone, cloth, carpet, and cork. Other materials may also be used, as desired. Patterned paper, not shown, may be added on top of surface layer 101 to create a desired appearance for the finished product. Plastic composite substrate layer 102 is extruded out, and may be made from a mixture including one or more of PVC powder, coarse whiting and light calcium compound powder, stabilizer, PE wax, internal lubricant, plasticizer, and impact modifier. Plastic composite substrate layer 102 may be a uniform mixture of two or more of the above components, such that it has a single texture, appearance, and physical properties. Some components might be omitted, such as the light calcium compound powder.

As described above, engineered flooring plank 100 may be produced by first mixing a number of components, such as PVC powder, coarse whiting and light calcium compound powder, stabilizer, PE wax, internal lubricant, plasticizer, and impact modifier by proportion of weight. This mixture may then be stirred in order to achieve an even consistency. In some aspects, the formula used for the surface layer may vary based upon the hardness and resistance to impact needs of a particular plank. Other technical requirements may also dictate the composition of surface layer 101. For example, the impact requirements of a project might dictate that surface layer 101 be made of materials that will provide a cushioning feature, such that the resulting flooring made from the planks might more easily absorb pressure from a person walking on the floor.

The mixture used to construct surface layer 101 includes both hot mixing and cold mixing. During hot mixing the temperature may be controlled to be between 110-120° C. The mixture may be fully mixed and stirred at this temperature. The mixture may then be cooled to 40-45° C. and continued to be stirred. After this, the mixture may be extruded through the extruder, which is a compound of plastic composite base material, like plastic composite substrate layer 102. After this, surface layer 101 may be tiled onto the extruded plastic composite substrate layer 102 in a fixed position. This may be done using a three-roll calender to bond and paste surface layer 101 and plastic composite substrate layer 102 together. The material of plastic composite substrate layer 102 is formed in a single step, which allows continuous automated production. The temperature of bonding and pasting surface layer 101 from the plastic composite material extrusion and the material of plastic composite substrate layer 102 is controlled at around 150-200° C. The press roller of a multiple roll calender can be used to design a concave and/or a convex mold, which may be used to form various types of designs on surface layer 101. These molds may be used to improve the aesthetics of surface layer 101, to increase friction on surface layer 101, or for other purposes. After this, the layers may be bonded and pasted, and engineered flooring plank 100 may be cooled, sized into the desired size, and then cut into shape.

FIG. 2 illustrates an exemplary plank 200 according to some aspects of the present disclosure, using a two-layer substrate. In plank 200, a surface layer 201 is thermally compressed and pasted together with the substrate. Here, the substrate includes a first plastic composite substrate layer 221 and a second plastic composite substrate layer 222. The plastic composite base layer is extruded with first plastic composite substrate layer 221 and second plastic composite substrate layer 222.

The two plastic composite substrate layers 221, 222 are both extruded and compounded by the mixture containing PVC powder, coarse whiting and light calcium compound powder, stabilizer, PE wax, internal lubricant, plasticizer, and impact modifier. In some aspects, it may be advantageous to use two or more layers of plastic composite substrates, in order to allow the two layers to have different physical properties.

For example, first plastic composite substrate layer 221 of plastic composite substrate may have higher requirements on hardness and resistance to impact. This requirement may be met by constructing the layer from a slightly different mixture, such as increasing a ratio of coarse whiting in the plastic composite base material formula and decreasing a ratio of PVC powder and light calcium. Second plastic composite substrate layer 222 of plastic composite substrate may have lower requirements on hardness and resistance to impact than first plastic composite substrate layer 221. In second plastic composite substrate layer 222, the mixture may have an increased ratio of PVC powder and light calcium, and a decreased ratio of coarse whiting in the plastic composite base material formula. Second plastic composite substrate layer 222 may also add a foaming agent.

First plastic composite substrate layer 221 and second plastic composite substrate layer 222 may be produced using a double inlet to send different plastic composite base material mixtures into an extruder. The compounded two-layered structure, plastic composite substrate layers 221, 222 may be extruded by an extruder with the same extrusion mold. The two plastic composite substrate layers 221, 222 may be thermally compressed and pasted with surface layer 201. The composite material of the two plastic composite substrate layers 221, 222 may be formed in a single step, which may allow for continuous automated production. Since second plastic composite substrate layer 222 uses foam structure, with the added foaming agent, second plastic composite substrate layer 222 may use fewer raw materials in production, which may result in a more economical production cost.

FIG. 3 illustrates an exemplary plank 300 according to some aspects of the present disclosure, using a three-layer substrate. In this plank 300, a surface layer 301 and the layers of the substrate 321, 322, 323 are attached to one another using thermal compression. The plastic composite base layer may be extruded and compounded by three layers of plastic composite substrates 321, 322, 323. The three layers of plastic composite substrates 321, 322, 323 may be extruded and compounded by a mixture containing one or more of PVC powder, coarse whiting and light calcium compound powder, stabilizer, PE wax, internal lubricant, plasticizer, and impact modifier.

The different layers of the substrate 321, 322, 323 may have different compositions, in order to allow plank 300 to have desirable characteristics and physical properties. For example, second layer 322 may have lower requirements on hardness and resistance to impact. This may allow the use of an increased ratio of PVC powder and light calcium, and a decreased ratio of coarse whiting. A foaming agent may also be used in second layer 322, which may allow for less material to be in second layer 322, which may reduce production costs. First layer 321 and third layer 323 may have higher requirements with regards to hardness and resistance to impacts, and so these layers 321, 323 may be constructed using a higher ratio of coarse whiting in the plastic composite base material formula and a lower ratio of PVC powder and light calcium. First layer 321 and third layer 323 can be made of the identical material or could be made of different materials.

The three-layer 321, 322, 323 substrate may be produced in a number of manners. One technique for producing such a substrate includes using triple inlets to send different plastic composite base material mixtures into the extruder. This three-layer 321, 322, 323 substrate may be extruded using an extruded with the same mold as other substrates, and is then thermally compressed and pasted with surface layer 301, as described above. The substrate is formed in a single process, allowing for continuous production in an automated manner.

Plank 300 may have advantages over plank 200, due to having an additional layer. For example, plank 300 may be harder and more resistant to impact than plank 200. For example, one plank produced using the structure of plank 300 was found to have a static bending intensity of 32 MPa, and elastic modulus of 1780 MPa, an impact strength of 160 kJ/m², and a contraction deformation rate of 0.25%. In a 4-hour “dipping detachment” test, where a sample of the plank is placed in 63° C. water for four hours and then placed ice at −20° C. for four hours, and showed no signs of stratification. Further, this plank had a formaldehyde content of 0 PPM in testing.

Further embodiments can be envisioned to one of ordinary skill in the art after reading this disclosure. In other embodiments, combinations or sub-combinations of the above disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

The specification and drawings are to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

1. An engineered plank for use in flooring comprising:
a surface layer; and
a composite base material layer comprising an extruded plastic composite core layer, wherein the surface layer is adhered to the composite base material layer by thermal compression applied to the surface layer and to the composite base material layer while the plastic composite core layer is being extruded, wherein the plastic composite core layer is produced from a mixture of polyvinyl chloride powder, coarse whiting powder, stabilizer, polyethylene wax, internal lubricant, plasticizer, and impact modifier.

2. The engineered plank of claim 1, wherein the surface layer is constructed using one or more of ceramic, tile, glass, rubber, plastic, paper, leather, metal materials, stone, cloth, carpet, and cork.

3. (canceled)

4. The engineered plank of claim 1, wherein the composite base material layer is produced by compounding and extruding a layer of plastic substrate.

5. The engineered plank of claim 1, wherein the composite base material layer is produced by compounding and extruding two or more layers of plastic substrate.

6. A method of producing an engineered plank for use in flooring, the method comprising:
mixing polyvinyl chloride powder, coarse whiting powder, stabilizer, polyethylene wax, internal lubricant, plasticizer, and impact modifier in predetermined proportions, to form a mixture;
extruding the mixture to form a plastic composite base material layer; and
thermally compressing the plastic composite base material layer with a surface layer, using a calender, the plastic composite base material being compressed by a a continuous-press process using thermal compression without using intermediate adhesive materials.

7. The method of claim 6, wherein the mixture is mixed using both hot mixing and cold mixing.

8. The method of claim 7, wherein hot mixing comprises controlling a temperature of the mixture to be between 110° C. and 120° C.

9. The method of claim 6, wherein thermally compressing the surface layer includes fusing the surface layer to the plastic composite base material at a temperature between 150° C. and 200° C.

10. The method of claim 6, wherein the surface layer is thermally compressed on the plastic composite base material using the calender.

11. The method of claim 7, wherein the hot mixing comprises stirring the mixture at a temperature controlled to be between 110° C. and 120° C., the method further comprising cooling the mixture, and wherein the cold mixing comprises stirring at a temperature between 40° C. and 45° C.

12. The method of claim 6, wherein extruding comprises feeding the mixture into an extruder via a feed port, and the method further comprising:
compressing the surface layer and the plastic composite base material, wherein the calender is a three-roller calender with a roller of the three-roller calender using a concave-convex patterned mold at a temperature of around 150° C.

13. The method of claim 6, wherein extruding comprises feeding the mixture into an extruder via a feed port, and the method further comprising:
compressing the surface layer and the plastic composite base material, wherein the calender is a calender with more than three rollers.
